(19) United States
(12) Patent Application Publication
(10) Pub. No.: US 2009/0007183 A1
(43) Pub. Date: Jan. 1, 2009

(54) VIDEO RECORDING APPARATUS AND BROADCAST RECEIVING APPARATUS

(75) Inventor: Yoshihisa Kizuka, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/163,689

(22) Filed: Jun. 27, 2008

(30) Foreign Application Priority Data
Jun. 29, 2007 (JP) P2007-172805

(51) Int. Cl. H04N 5/445; H04N 5/91; G06F 13/00

(52) U.S. Cl. 725/58; 386/83; 386/E05.043; 386/E05.001

(57) ABSTRACT

According to one embodiment, a video recording apparatus including a recording device recording video data and a communication device performing a communication with an external tuner via a network, has the following units. Namely, the video recording apparatus has: a viewable channel presenting request unit transmitting a presenting request of viewable channel information showing viewable channels set at the external tuner to the external tuner by the communication device; and a video recording reservation setting unit setting a video recording reservation to record external video data transmitted from the external tuner via the network to the recording device, in accordance with the viewable channel information presented from the external tuner in response to the presenting request.

### CROSS-REFERENCE TO RELATED APPLICATIONS

This application is based upon and claims the benefit of priority from Japanese Patent Application No. 2007-172805, filed Jun. 29, 2007, the entire contents of which are incorporated herein by reference.

### BACKGROUND

1. Field

One embodiment of the invention relates to a video recording apparatus recording video data acquired from a received broadcast wave, and a broadcast receiving apparatus receiving the broadcast wave.

2. Description of the Related Art

Conventionally, a video recording apparatus recording video data acquired from a received broadcast wave to a recording medium such as a hard disk, a DVD-RAM, a DVD-R, is known. Various types of apparatuses are conventionally known as the above-stated type of video recording apparatus.

For example, a video recording apparatus, in which a transfer instruction of video data to be recorded is transmitted to a connected external tuner, and a reserved recording by using the external tuner is performed, is disclosed in Japanese Patent Application Publication (KOKAI) No. 2004-363649 (Patent Document 1).

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a configuration of a video recording reservation system connecting a DVD recorder and an STB according to an embodiment of the invention;

FIG. 2 is an exemplary block diagram showing an internal configuration of the DVD recorder in the embodiment;

FIG. 3 is an exemplary block diagram showing an internal configuration of the STB in the embodiment;

FIG. 4 is an exemplary flowchart showing an operation procedure of a reserved recording operation of the DVD recorder in the embodiment;

FIG. 5 is an exemplary flowchart showing an operation procedure of another reserved recording operation of the DVD recorder in the embodiment;

FIG. 6 is an exemplary flowchart showing an operation procedure of an operation of an STB corresponding to a DVD recorder in the embodiment;

FIG. 7 is an exemplary flowchart showing the operation procedure of another operation of the STB corresponding to the DVD recorder in the embodiment;

FIG. 8 is an exemplary view showing a transmission/reception sequence of data in the DVD recorder and the STB in the embodiment;

FIG. 9 is an exemplary view showing another transmission/reception sequence of data in the DVD recorder and the STB in the embodiment; and

FIG. 10 is an exemplary view showing an example of a program list presented from the STB in the embodiment.

### DETAILED DESCRIPTION

Various embodiments according to the invention will be described hereinafter with reference to the accompanying drawings. In general, according to one embodiment of the invention, a video recording apparatus including a recording device recording video data and a communication device performing a communication with an external tuner via a network has the following units. Namely, the video recording apparatus has: a viewable channel presenting request unit transmitting a presenting request of viewable channel information showing viewable channels set at the external tuner, to the external tuner by the communication device; and a video recording reservation setting unit setting a video recording reservation to record external video data transmitted from the external tuner via the network to the recording device, in accordance with the viewable channel information presented from the external tuner in response to the presenting request.

Besides, a video recording apparatus including a recording device recording video data and a communication device performing a communication with an external tuner via a network has the following units. Namely, the video recording apparatus has: a video recording reservation setting unit setting a video recording reservation to record external video data transmitted from the external tuner via the network, to the recording device; a program information presenting request unit transmitting a presenting request of program information to the external tuner by the communication device at a predetermined time before a video recording start time shown by the video recording reservation set by the video recording reservation setting unit; a judging unit judging whether there is a change in a programming to be broadcasted or not in accordance with the program information presented from the external tuner in response to the presenting request; and a video recording reservation changing unit changing a video recording time of the video recording reservation set by the video recording reservation setting unit in accordance with the program information presented from the external tuner when the judging unit judges that there is the change in the programming.

Further, a broadcast receiving apparatus including a receiving device selecting and receiving a broadcast wave, and a communication device performing a communication with a video recording apparatus via a network, has the following units. Namely, the broadcast receiving apparatus has: a viewable channel presenting unit presenting viewable channel information to the video recording apparatus by using the communication device when the communication device receives a presenting request of the viewable channel information showing viewable channels from the video recording apparatus.

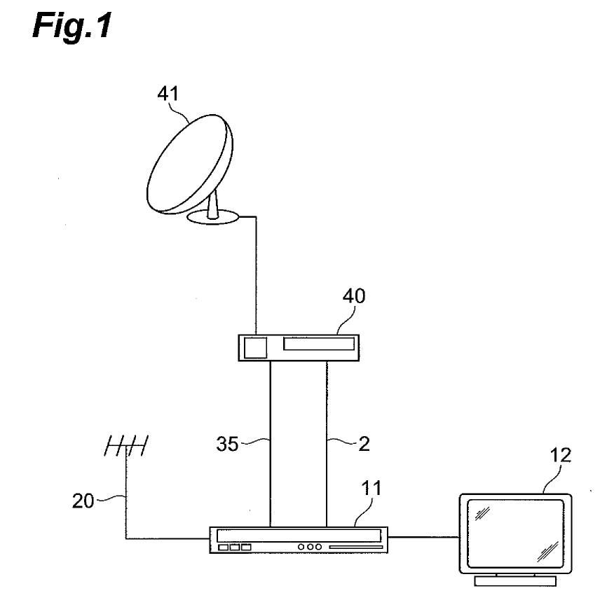

FIG. 1 is a block diagram showing a configuration of a video recording reservation system connecting a DVD recorder 11 as a video recording apparatus and an STB (Set Top Box) 40 as a broadcast receiving apparatus according to an embodiment of the present invention. This video recording reservation system has a configuration in which the DVD recorder 11 and the STB 40 are connected by using a network 2 such as Ethernet (a registered trademark) and a wireless LAN.

### (Configuration of DVD Recorder)

The DVD recorder 11 houses an HDD and a DVD drive, though the details will be described later, receives a broadcast wave, and a video/audio recording, recording digital data such as video data in, for example, an MPEG (Moving Picture Image Coding Experts Group)-2 format and audio data to an HDD or an optical disk D (for example, a DVD-RAM, a DVD-R, and so on) not shown in FIG. 1 can be performed. Besides, it is also possible to read the recorded digital data in the MPEG-2 format and to reproduce video signals and audio signals.

A television 12 as a display apparatus displaying video by using the reproduced video data is connected to the DVD recorder 11. The television 12 can display reproduced video and an operation screen by the DVD recorder 11. The television 12 acquires the video signals and audio signals from the received broadcast wave, and performs a video display and an audio output of a program by using the video signals and audio signals. Besides, the television 12 performs the video display and the audio output of the program by using the video signals and the audio signals reproduced by the DVD recorder 11.

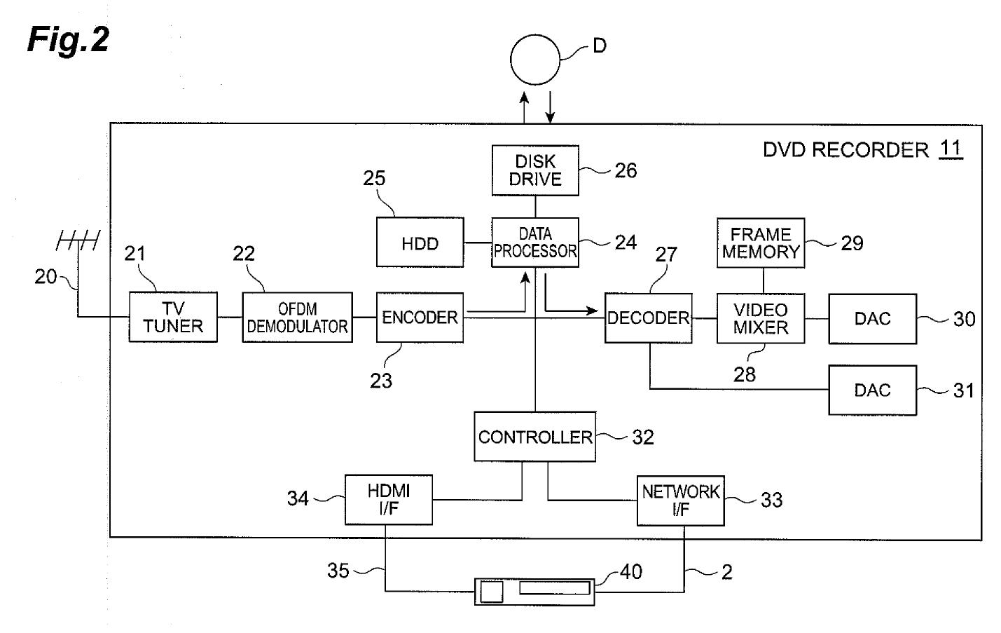

FIG. 2 is a block diagram showing an internal configuration of the DVD recorder 11. Broadcast signals of a terrestrial digital broadcasting received by a terrestrial broadcast receiving antenna 20 are inputted to a TV tuner 21.

The TV tuner 21 is a tuner for the terrestrial digital broadcasting, and selects the broadcast signals of a predetermined channel from the supplied broadcast signals. The broadcast signals selected by the TV tuner 21 are supplied to an OFDM demodulator 22. The OFDM demodulator 22 performs a demodulation process of the video data and audio data in digital format, and outputs to an encoder 23.

The encoder 23 compresses the inputted video data based on an MPEG-2 standard, and outputs compressed video data. The encoder 23 also compresses the audio data based on, for example, an AC (Audio Compression)-3 standard, and converts into compressed audio data to output.

A signal process is performed for the compressed video data and audio data to be formats suitable for a recording at the encoder 23, and they are outputted to a data processor 24. The video data and audio data encoded at the encoder 23 and management information created at a controller 32 are recorded on the optical disk D such as the DVD-RAM inserted in a later-described HDD 25 or DVD drive 26 via the data processor 24.

The video data and audio data recorded on the optical disk D inserted in the HDD 25 or the DVD drive 26 are outputted to a decoder 27 via the data processor 24. The decoder 27 has functions to separate the video data and audio data from input data, and to decode each of them.

The video data outputted from the decoder 27 is inputted to a video mixer 28. A combination of the inputted video data, text data and image data is performed at the video mixer 28 by using a frame memory 29 as a buffer. Besides, an output of the video mixer 28 is converted into video signals in analog format by a DAC 30 (Digital to Analog Converter), and thereafter, outputted to outside. The audio data outputted from the decoder 27 is also converted into audio signals in analog format by a DAC 31 similarly, and thereafter, outputted to outside.

The controller 32 has an MPU (Micro Processing Unit), a ROM and a RAM. Control programs and programs executed by the MPU are written to the ROM. The RAM is made to be possible to provide a work area necessary for the execution of the program by the MPU. The controller 32 controls the above-stated respective modules in accordance with the control programs stored in the ROM, and totally controls set operations such as the video recording and reproducing.

Besides, the controller 32 receives operational information of a not-shown remote control operated by a user via a not-shown infrared receiving portion, and controls operations in accordance with the received information. Further, the controller 32 controls operations of a network interface (a network I/F) 33 performing a communication with the other apparatus (for example, an STB 40) connected to the network 2. Further, the controller 32 provides a library management function.

The controller 32 is used for the recording of data by the HDD 25 or the DVD drive 26 (here, it is assumed to be the video recording), and controls an execution of a reserved recording based on information (hereinafter, referred to as “video recording reservation information”) set in advance prior to the recording of the data (video recording). The video recording reservation information is information necessary for performing the video recording, and information such as the number of channel, a video recording start time, a video recording end time, a video recording mode (information such as a type of a codec used for the video recording, and a bit rate) are contained.

Besides, the controller 32 stores and holds the video recording reservation information as stated above in a video recording reservation table. The controller 32 monitors the current time, and controls so that a video recording operation is started when the video recording start time of any of the video recording reservation information stored in the video recording reservation table has come.

Namely, the controller 32 selects the channel specified by the number of channel of the video recording reservation information by the TV tuner 21 when the video recording start time has come, activates the encoder 23 in accordance with the video recording mode, and performs the video recording by recording the video data to the HDD 25 or the optical disk D.

Further, the controller 32 also monitors the current time during the video recording, stops the video recording operation when the video recording end time has come, and saves the data (video data and audio data) recorded by the video recording operation. Incidentally, the video recording reservation table is stored in the HDD 25 so as not to be deleted even when the power of the DVD recorder 11 is turned off.

The network I/F 33 is used to transmit/receive data with the STB 40 connected to the network 2. The controller 32 interprets the data received via the network I/F 33, generates data to be transmitted to the STB 40 and other not-shown video recording apparatuses, and transmits the data via the network I/F 33.

Besides, the DVD recorder 11 has an HDMI I/F 34. The HDMI I/F 34 receives high-definition video data in digital format and audio data in digital format from the STB 40 in accordance with an HDMI standard via an HDMI cable 35.

The DVD recorder 11 can use an Electronic Program Guide. The DVD recorder 11 can display a program table of programs to be broadcasted at channels and a time zone within a specified range, on the television 12, by using the Electronic Program Guide. Program table data necessary for the use of the EPG can be acquired from, for example, SI (Service Information) information superposed on the broadcast wave.

Besides, it is also possible to acquire the program table data from a server (not-shown) opening the program table data, when the DVD recorder 11 is connected to not-shown Internet. Incidentally, the program table data is stored in the HDD 25 so as not to be deleted even when the power is turned off.

### (Network Video Recording Reservation Service)

The controller 32 can provide a network video recording reservation service function for the STB 40 and other not-shown video recording apparatuses connected to the network 2. The controller 32 provides the network video recording reservation service function, and thereby, the video recording reservation information is opened to the STB 40 and the other video recording apparatuses, and at the same time, it becomes possible to perform a setting of the video recording reservation from these apparatuses.

The controller 32 performs a communication with the STB 40 and the other not-shown video recording apparatuses by using an UPnP (Universal Plug and Play) standard to realize the function as stated above. However, it is also possible to realize the above-stated function by using another similar protocol.

An object of the UPnP is to realize discovery and operation of apparatuses (STB, printer, scanner and so on) connected to a network without any complicated settings, in the network in which operations based on a TCP/IP (Transmission Control Protocol/Internet Protocol) are performed.

In the UPnP, an apparatus providing any function for the apparatuses connected to the network is called as a “device”, and a function provided by the “device” is called as a “service”. Besides, an apparatus at a side using or controlling the “service” provided by the “device” is called as a “control point”. Incidentally, these “device” and “control point” are conceptual models to define the protocol. Accordingly, there is a case when an actual apparatus (for example, the DVD recorder 11) has both the function as the “device” and the function as the “control point”.

An SSDP (Simple Service Discovery Protocol) is used to discover the video recording apparatus and the “service” provided by the video recording apparatus. The “device” can notify that the “device” and the “service” exist on the network, and the “control point” can search a desired “device”. It is possible to acquire attribute information of the video recording apparatus described in an XML (Extensible Markup Language) format called as a “Device Description”, from the apparatus discovered by the SSDP.

An “UDN” (Unique Device Name) being an identifier to uniquely identify an apparatus, a “FriendlyName” used for a display and so on, a list of “services” to be provided, and so on are described in the “Device Description”. Similarly, it is also possible to acquire data in the XML format called as a “Service Description” as for the “service”, and executable operations and so on are described therein. The operations described in the “Service Description” are called by using an SOAP (Simple Object Access Protocol).

When the DVD recorder 11 provides the network video recording reservation service as the “device”, the controller 32 executes the network video recording reservation service to accept the video recording reservation information transmitted (transferred) from the video recording apparatus connected to the network 2. The network video recording reservation service is realized as an SRS (Scheduled Recording Service) being a “service” of the above-stated UPnP.

Besides, the controller 32 also executes a function as the “control point” for the network video recording reservation service activating at another video recording apparatus. In this case, the controller 32 transmits a video recording reservation acquiring request, a video recording reservation setting request, and so on for the network video recording reservation service activating at the other video recording apparatus.

A CDS (Contents Directory Service) is one of services defined for the video recording apparatus such as the DVD recorder 11 and the broadcast receiving apparatus such as the STB 40. The DVD recorder 11 as the control point accesses the STB 40 as the device providing the CDS, and thereby, it becomes possible to acquire the attribute information of contents such as a video and music from the STB 40.

In the CDS, the attribute information of one content is called as an object. An “Object ID” in which a unique value is assigned by each content, a “title name”, and so on are contained as the attribute information. Besides, there also is a “URL” to acquire data of the contents as one of the attribute information. The DVD recorder 11 as the control point can also access the URL acquired from the STB 40, and reproduce the video signal by acquiring the data in accordance with an HTTP (Hyper Text Transport Protocol).

Operation commands such as a “Browse” command used to acquire the attribute information of the contents, a “Search” command used to search the attribute information of the contents satisfying specified conditions, and a “Create Object” command used to create new attribute information are defined in the CDS.

### (Configuration of STB)

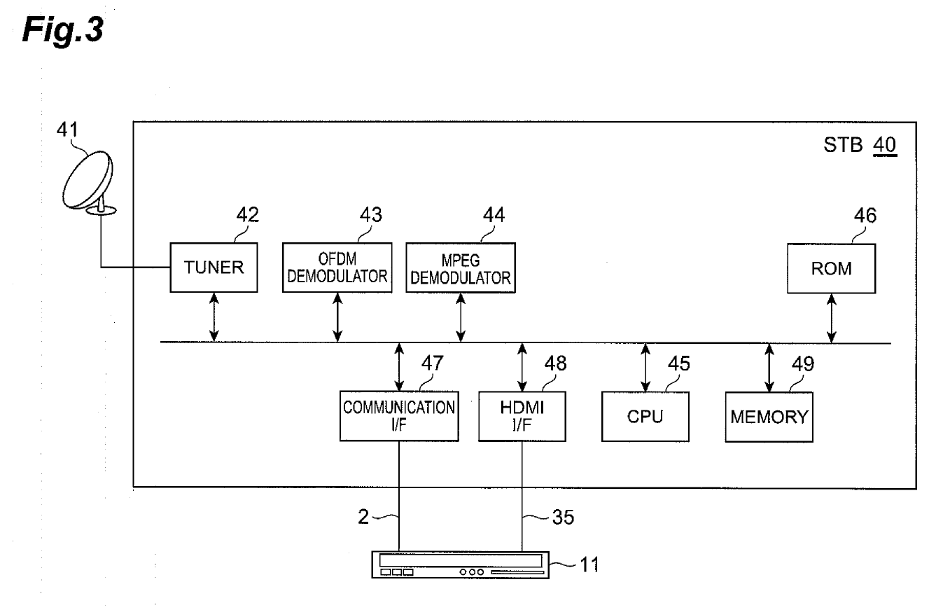

The STB 40 has a tuner 42, an OFDM demodulator 43, an MPEG demodulator 44, a CPU 45, a ROM 46, a communication I/F 47, an HDMI I/F 48, and a memory 49 as shown in FIG. 3. This STB 40 has a function as an external tuner connected to receive a broadcasting of a viewable channel, and transmitting the video data acquired by receiving the broadcasting of the viewable channel to the DVD recorder 11.

Broadcast signals of a satellite digital broadcasting received by a BS/CS digital broadcast receiving antenna 41 are inputted to the tuner 42. The tuner 42 selects the broadcast signal of a predetermined channel from the supplied broadcast signals. The broadcast signal selected at the tuner 42 is supplied to the OFDM demodulator 43. The OFDM demodulator 43 performs a demodulation process of the video data and audio data in digital format, and outputs to the MPEG demodulator 44.

The MPEG demodulator 44 compresses the inputted video data based on the MPEG-2 standard, and outputs the compressed video data. The MPEG demodulator 44 also compresses the audio data based on, for example, an AC (Audio Compression)-3 standard, converts into the compressed audio data to output. The CPU 45 is activated in accordance with a predetermined control program, performs an input/output of signals with other constitutional elements, and performs the operation control of all over the STB 40. The ROM 46 stores programs and so on executed by the CPU 45.

The communication I/F 47 performs a transmission/reception of data between the DVD recorder 11 connected to the network 2. The HDMI I/F 48 transmits the high-definition video data in digital format and audio data in digital format for the DVD recorder 11 in accordance with the HDMI standard via the HDMI cable 35. Later-described viewable channel information and so on are stored in the memory 49.

### (Operation Contents of DVD Recorder)

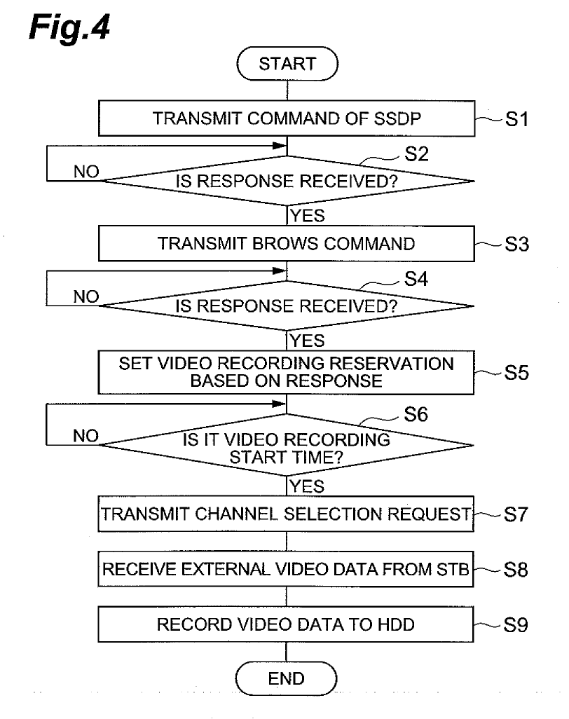

Next, operation contents of the DVD recorder 11 when the broadcasting of the viewable channel is received by using the STB 40, and the reserved recording of a program is performed at the DVD recorder 11 are described. FIG. 4 is a flowchart showing operation procedures when the DVD recorder 11 performs the reserved recording concerning the program of the viewable channel.

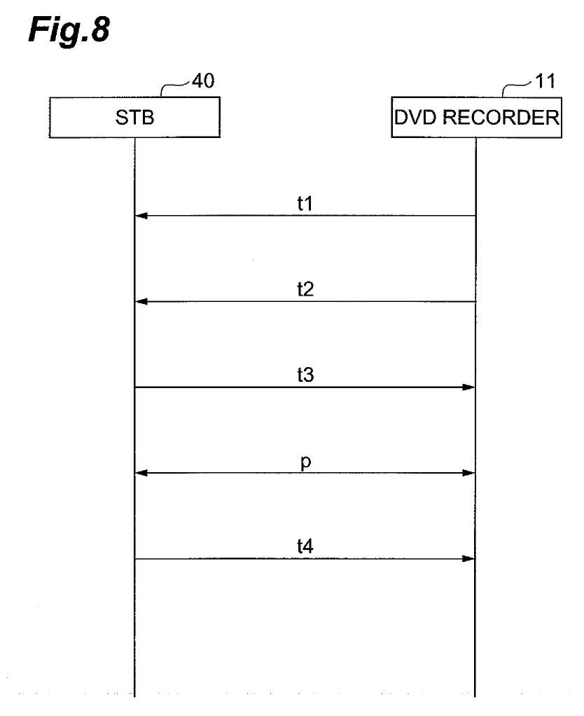

At first, the DVD recorder 11 transmits a command of the SSDP to the respective apparatuses including the STB 40 connected to the network 2 (S1), as shown in FIG. 4. A data transmission t1 shown in FIG. 8 is performed by the execution of the S1. Incidentally, FIG. 8 is a view showing a transmission/reception sequence of data in the DVD recorder 11 and the STB 40.

Subsequently, the DVD recorder 11 waits until the controller 32 receives a response of the command of the SSDP (S2) The controller 32 performs operations as a viewable channel presenting request unit when the response is received, and transmits a presenting request of the viewable channel information to the STB 40 by using the “Browse” command of the CDS (S3). A data transmission t2 is performed by the execution of the S3. In the S3, the controller 32 may transmit the “Search” command of the CDS to the STB 40.

Besides, the DVD recorder 11 waits until a response from the STB 40 is received (S4). When the controller 32 receives the response (when a data transmission t3 is performed), the controller 32 performs operations as a video recording reservation setting unit and sets the video recording reservation based on the audio/visual channel information contained in the received response and contents specified by a user (S5). Namely, the controller 32 generates the video recording reservation information, and stores the generated video recording reservation information to the video recording reservation table.

The above-stated video recording reservation is a reservation concerning the video recording in which the video data transmitted from the STB 40 (external video data) is recorded on the HDD 25 or the optical disk D. Incidentally, the viewable channel information showing the viewable channel and the URL showing the address of the STB 40 are contained in the response received in the S4, though the details will be described later.

Subsequently, the controller 32 waits until the video recording start time of the video recording reservation set in the S5 has come (S6), then advances the operation to S7 when the video recording start time has come to perform operations as a positional information acquiring unit, and acquires the URL (positional information) of the STB 40 from the response presented from the STB 40. Besides, the controller 32 performs operations as a channel selection requesting unit by using the acquired positional information, and performs a channel selection request to the STB 40 (transmits the channel selection request).

Subsequently, the controller 32 performs a later-described authentication procedure P, and thereafter, receives the external video data from the STB 40 (S8), and performs the video recording by recording the received external video data to the HDD 25 (S9). The reserved recording completes concerning the program of the viewable channel when the S9 is finished. A data transmission t4 shown in FIG. 8 is performed in the S8.

As stated above, the DVD recorder 11 transmits the presenting request of the viewable channel information to the STB 40 by the operations of the controller 32, and sets the video recording reservation of the program of the viewable channel by using the viewable channel information presented from the STB 40.

Accordingly, it is possible for the user to set the video recording reservation concerning the program of the viewable channel, and to easily perform the video recording reservation of the program of the viewable channel without taking a trouble to specify the viewable channel. Consequently, the DVD recorder 11 is able to perform the video recording of the program of the viewable channel easily.

Besides, the DVD recorder 11 acquires the address of the STB 40 from the response presented from the STB 40, and performs the access to the STB 40 in accordance with the address. Accordingly, it is also possible for the user to perform the channel selection request to the STB 40 directly without specifying the address of the STB 40.

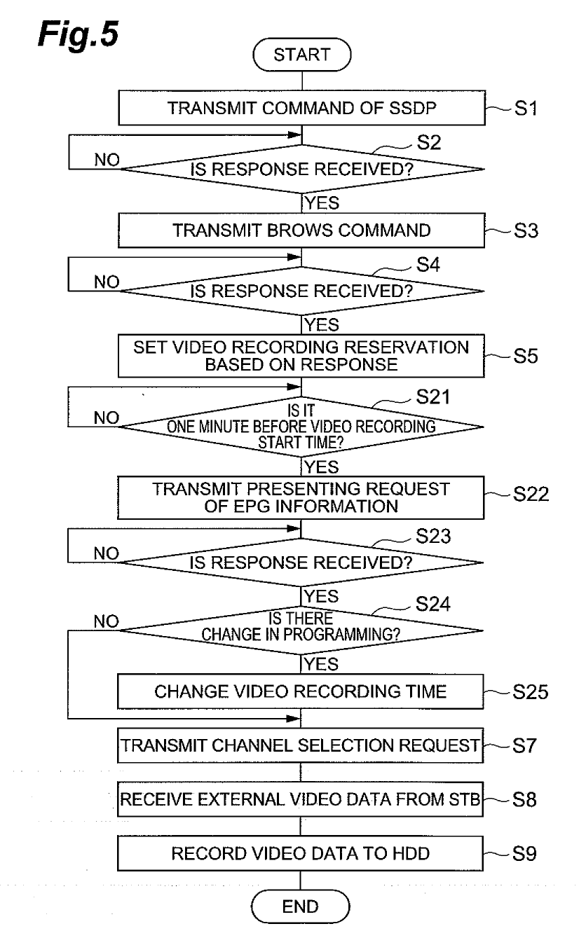

Besides, it is also possible for the DVD recorder 11 to perform the reserved recording concerning the program of the viewable channel along a flowchart shown in FIG. 5.

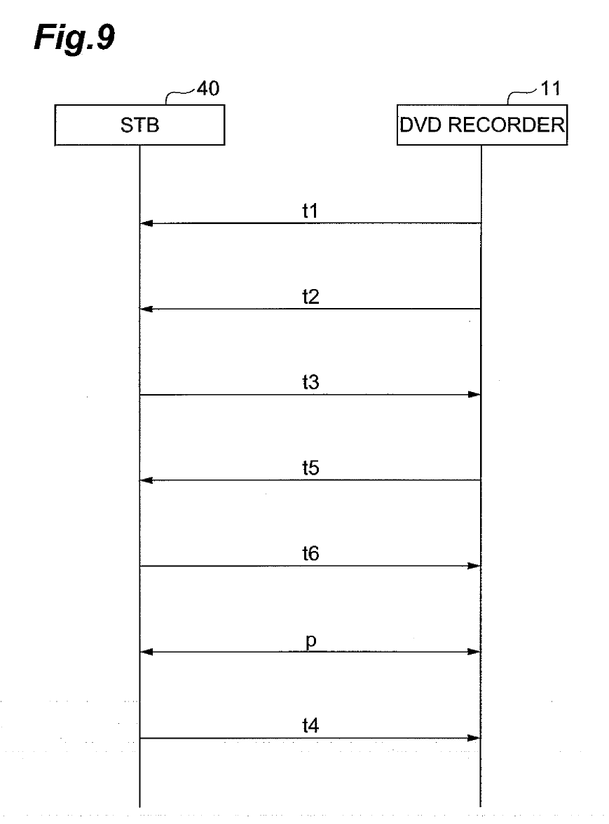

In this case, the DVD recorder 11 advances the operation to S21 after the controller 32 performs the S1 to the S5 as same as the above, and judges whether it is one minute before (the time may be other times such as two minutes before, 30 seconds before, or the like) the video recording start time or not. The controller 32 advances the operation to S22 to perform operations as a program information presenting request unit, and transmits the presenting request of EPG information (program information) to the STB 40 (S22) when it is one minute before the video recording start time. At this time, a data transmission t5 shown in FIG. 9 is performed. Incidentally, FIG. 9 is a view showing a transmission/reception sequence of data corresponding to FIG. 5 in the DVD recorder 11 and the STB 40.

Subsequently, the controller 32 waits until a response from the STB 40 is received (until a data transmission t6 shown in FIG. 9 is performed) (S23). The controller 32 performs operations as a judging unit when the response is received, and judges whether there is a change in a programming or not, based on the received response (S24).

Here, the controller 32 advances the operation to S25 when there is the change in the programming, and otherwise, completes the reserved recording operations after the S7, S8, S9 are performed as same as the above are performed after the execution of the authentication procedure P of a DTCP-IP (Digital Transmission Content Protection over Internet Protocol) shown in FIG. 9, without performing the S25. Incidentally, the DTCP-IP is a standard to prevent an unauthorized copy of contents resulting from a wiretapping of a packet by encrypting the contents to transmit to the network 2.

The response received in the S23 is constituted by metadata described in the XML format such as a program list 100 and later-described next program information is contained therein, though the details will be described later.

The controller 32 performs the operation as a video recording reservation changing unit in accordance with the EPG information presented from the STB 40 in the S25, and changes video recording times (the video recording start time and the video recording end time) concerning the set video recording reservation (the corresponding video recording reservation information among the video recording reservation information stored on the video recording reservation table)

Accordingly, when there is the change in the programming, the DVD recorder 11 can perform the video recording while changing the video recording time.

Conventionally, when the video recording of the program received by the STB is performed at the DVD recorder 11, there is a case when the programming to be broadcasted is changed due to some situation (for example, an extension of broadcast time of sports, a break-in of a special newscast, and so on) after the video recording reservation is set to the DVD recorder 11. In this case, there has been a case in which the video recording of a part or all of an initial reserved program is changed to another program to be recorded, and the video recording of the reserved program is not performed in the conventional video recording apparatus.

However, the DVD recorder 11 according to the present embodiment performs the presenting request of the program information to the STB 40 at the time when it is one minute before the video recording start time, and in addition, performs the video recording in accordance with the program information presented from the STB 40 or performs the video recording after changing the video recording time when there is the change in the programming.

Accordingly, it is possible for the DVD recorder 11 to perform the video recording corresponding to the programming after change and to surely perform the video recording of the initial reserved program, even when the programming is changed.

### (Operation Contents of STB)

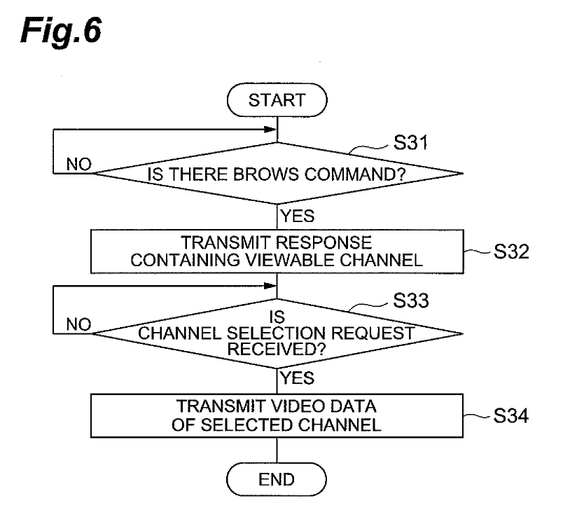

Next, operation contents of the STB 40 with correspond to the above-stated operations of the DVD recorder 11 are described. FIG. 6 is a flowchart showing an operation procedure of the STB 40. In the STB 40, the CPU 45 controls the operations.

The CPU 45 judges whether the command of the SSDP is received or not in addition to the operations shown in FIG. 6, and presents the response to the DVD recorder 11 by the communication I/F 47 when the command of the SSDP is received.

Next, the CPU 45 starts the operations in accordance with the flowchart shown in FIG. 6, and at first, judges whether the “Browse” command is received or not (S31). The CPU 45 performs the operation as the viewable channel presenting unit when the “Browse” command is received, and presents the viewable channel information by transmitting the response containing the viewable channel information and the URL showing the address of the STB 40 (S32).

Besides, the CPU 45 waits until the channel selection request is received (S33), and transmits the video data of the program broadcasted at the channel selected by the tuner 42 to the DVD recorder 11 as the external video data when the channel selection request is received (S34). After that, the CPU 45 completes the operation.

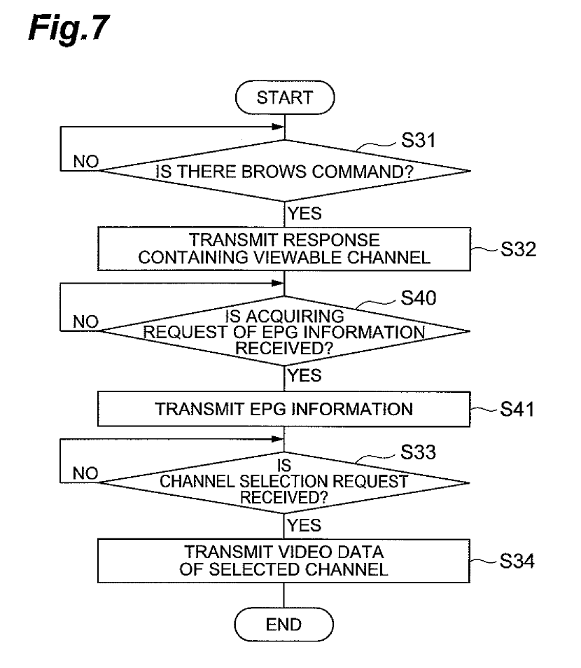

Besides, the STB 40 is also able to perform the operations along FIG. 7. In this case, the CPU 45 waits until the presenting request of the EPG information is received from the DVD recorder 11 (840) after the S31, S32 are executed as same as the above. The CPU 45 performs the operation as the program information presenting unit when the presenting request of the EPG information is received, and presents the program information to the DVD recorder 11 by transmitting the program list 100 (S34). After that, the CPU 45 completes the operation after executing the S33, S34 as same as the above.

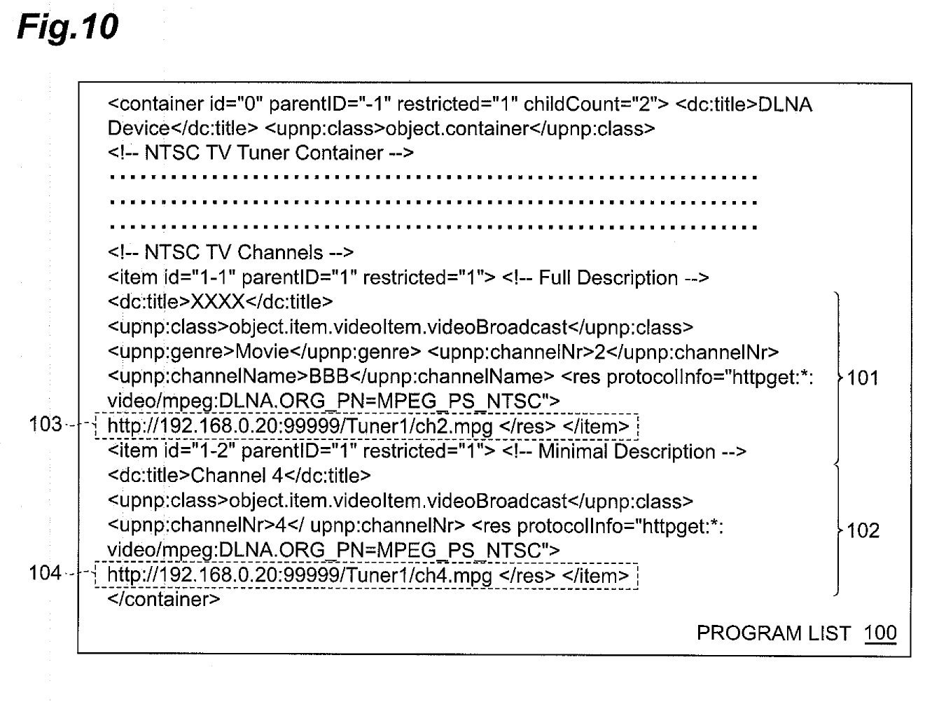

Here, the program list 100 is the data described in the XML format, and has a program tag 101 showing the program information concerning a currently broadcasting program (the program during receiving) and a program tag 102 showing next program information concerning a next program to be broadcasted next, as shown in FIG. 10. Both contain URLs 103 and 104 showing the address of the STB 40. Incidentally, the program list 100 can be defined in detail in accordance with a DLNA guideline (Digital Living Network Alliance guideline).

The STB 40 performs the operations as stated above, performs the operations such as presenting the program list 100 in response to the request from the DVD recorder 11, and thereby, it becomes possible for the DVD recorder 11 to set the video recording reservation by using the viewable channel information. Besides, when the programming is changed, it becomes possible for the DVD recorder 11 to perform the video recording while fluidly changing the video recording reservation.

The description in the above is to describe the embodiments of the invention and, in no case, limits the apparatus and method of the invention, so that various modifications can be embodied with ease. Further, the apparatus and method structured by appropriately combining the components, the functions, the features or the steps of the method in the respective embodiments are also within the scope of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video recording apparatus comprising a recording device for recording video data and a communication device for performing a communication with an external tuner via a network, said video recording apparatus comprising:
a viewable channel presenting request module configured to transmit a presenting request of viewable channel information showing viewable channels set at the external tuner, the presenting request being transmitted to the external tuner by the communication device; and
a video recording reservation setting module configured to set a video recording reservation to record external video data transmitted from the external tuner via the network to the recording device in accordance with the viewable channel information presented from the external tuner in response to the presenting request.

2. The video recording apparatus of claim 1, wherein said viewable channel presenting request module is configured to transmit the presenting request by using a command to acquire or search attribute information concerning functions provided by the external tuner.

3. The video recording apparatus of claim 1, further comprising a positional information acquiring module configured to acquire positional information of the external tuner from presentation data presented by the external tuner in response to the presenting request.

4. The video recording apparatus of claim 3, further comprising a channel selection requesting module configured to request a channel selection to the external tuner by using the positional information acquired by said positional information acquiring module.

5. A video recording apparatus comprising a recording device for recording video data and a communication device for performing a communication with an external tuner via a network, said video recording apparatus comprising:
a video recording reservation setting module configured to set a video recording reservation to record external video data transmitted from the external tuner, via the network, to the recording device;
a program information presenting request module configured to transmit, using the communication device, a presenting request of program information to the external tuner at a predetermined time before a video recording start time shown by the video recording reservation set by said video recording reservation setting module;
a determination module configured to determine whether or not there is a change in a programming to be broadcasted in accordance with the program information presented from the external tuner in response to the presenting request; and
a video recording reservation changing module configured to change a video recording time of the video recording reservation set by said video recording reservation setting unit in accordance with the program information presented from the external tuner when said determination module determines that there is a change in the programming.

6. The video recording apparatus of claim 5,
wherein said determination module is configured to determine whether or not there is the change in the programming in accordance with next program information contained in the program information.

7. A broadcast receiving apparatus comprising a receiving device for selecting and receiving a broadcast wave, and a communication device for performing a communication with a video recording apparatus via a network, said broadcast receiving apparatus comprising:
a viewable channel presenting module configured to present, using the communication device, viewable channel information to the video recording apparatus when the communication device receives a presenting request for viewable channel information showing viewable channels from the video recording apparatus.

8. The broadcast receiving apparatus of claim 7, wherein said viewable channel presenting module is configured to present the viewable channel information by using presentation data in an XML format containing the viewable channel information.

9. The broadcast receiving apparatus of claim 7, further comprising a program information presenting module configured to present program information to the video recording apparatus by using the communication device when the communication device receives the presenting request of the program information from the video recording apparatus.

10. The broadcast receiving apparatus of claim 9, wherein said program information presenting module is configured to present, as the program information, information of a program during receiving in which the receiving device receives the broadcast wave, and information of a next program to be broadcasted next to the program during receiving.
